(19) United States
(12) Patent Application Publication
(10) Pub. No.: US 2006/0091795 A1
(43) Pub. Date: May 4, 2006

(54) ORGANIC ELECTRO-LUMINESCENCE DISPLAY PANEL AND FABRICATING PROCESS THEREOF

(76) Inventors: Chih-Kwang Tzen, Pingtung County (TW); Chun-Chung Lu, Taichung County (TW); Shuenn-Jiun Tang, Hsinchu County (TW); Shih-Kuei Lo, Taoyuan County (TW); Jie-Huang Wu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,572

(22) Filed: Oct. 24, 2005

(30) Foreign Application Priority Data
Oct. 29, 2004 (TW) 93132906

(51) Int. Cl. H01J 1/62; H01J 63/04

(52) U.S. Cl. 313/506

(57) ABSTRACT

A process of fabricating an organic electro-luminescence display panel is provided. An organic electro-luminescence element is formed over a substrate and then a stack structure is formed over the substrate covering the organic electro-luminescence element. Wherein the stack structure comprises an organic polymer layer and an inorganic compound layer. The inorganic compound layer is composed of at least two inorganic films, and an interface between the inorganic films comprises a material intermixed with materials of the two inorganic films. The stack structure of the present invention is capable of effectively reducing penetration of atmospheric moisture and oxygen into the organic electro-luminescence element and thus effectively reducing the damage thereof.

### CROSS-REFERENCE TO RELATED APPLICATION

This application claims the priority benefit of Taiwan application serial no. 93132906, filed on Oct. 29, 2004. All disclosure of the Taiwan application is incorporated herein by reference.

### BACKGROUND OF THE INVENTION

1. Field of the Invention

The present invention relates to a display apparatus and fabricating process thereof. More particularly, the present invention relates to an organic electro-luminescence display panel and fabricating process thereof.

2. Description of Related Art

With the rapid advancement of modern society, the technology of semiconductor element and display apparatus has been highly developed. In organic electro-luminescence display apparatus, because of its wide view angle, lower manufacturing cost, high responsive speed (about hundreds times of that liquid crystals), low power consumption, wider working temperature range, lighter weight, smaller and thinner size, and direct-current drive used for portable machine, it will meet the future multimedia demand. Therefore, the organic electro-luminescence display apparatus have such a great potential to be the next generation flat panel display apparatus.

The emission mechanism of the organic electro-luminescence display is that when electrons and holes meet in the organic material layer, they will emit photons. But the electro-luminescence elements will fail because the common organic materials are easily humidified or oxidized so that the characteristics of these materials change, in turn change the emission mechanism thereof. Therefore, how to prevent the organic material layer from being humidified or oxidized is a very important subject during the fabricating process of organic electro-luminescence display panels.

FIG. 1 is a cross sectional view of a conventional organic electro-luminescence display panel. Referring to FIG. 1, the fabricating process of the conventional organic electro-luminescence display panel 120 starts from using the sealant 104, i.e. epoxy resin, to seal the substrate 100 and the package cover 108 and the ultraviolet light is applied to solidify the sealant 108.

However, the organic electro-luminescence element 102 and other elements are vulnerable to damage due to the atmospheric moisture and oxygen that penetrates through the sealant 104 into the space between the substrate 100 and the package cover 108. Therefore, some manufacturers have proposed disposing an absorbent layer 106 onto the package cover 108 so as to absorb the penetrated moisture. By this fabricating process, the organic electro-luminescence display panel merely can emit light from its bottom, but not emit from its top.

In addition, the sealed structure, formed by the package cover 108 and the sealant 104, of the organic electro-luminescence display panel is so heavy and thick that the display panel cannot be easily developed to be lighter and thinner. Moreover, the sealed structure can not be applied in the organic electro-luminescence display panel, whose substrate is flexible.

### SUMMARY OF THE INVENTION

Accordingly, the present invention is directed to thinner, lighter and flexible organic electro-luminescence display panel capable of reducing the possibility of being damaged by atmospheric moisture and oxygen.

The present invention is also directed to a process of fabricating the organic electro-luminescence display panel capable of reducing the possibility of being damaged by atmospheric moisture and oxygen.

According to an embodiment of the present invention, first an organic electro-luminescence element is formed over a substrate. Next, a stack structure is formed over the substrate to cover the organic electro-luminescence element. For example, the stack structure can be formed by sequentially forming an organic polymer layer and an inorganic compound layer or vice versa over the substrate. Wherein the inorganic compound layer is composed of at least two inorganic films, and the interface between the inorganic films comprises a material mixed with materials of the two inorganic films.

According to an embodiment of the present invention, the organic electro-luminescence display panel comprises a substrate, an organic electro-luminescence element and a stack structure. Wherein the organic electro-luminescence element is disposed over the substrate. The stack structure covers the organic electro-luminescence element and is composed of an organic polymer layer and an inorganic compound layer, wherein the inorganic compound layer comprises at least two inorganic films, and the interface between the inorganic films comprises a material mixed with materials of the two inorganic films.

According to an aspect of the present invention, the organic electro-luminescence display panel comprises the stack structure composed of the organic polymer layer and the organic compound layer, the stack structure can effectively reduce the possibility of the organic electro-luminescence element being damaged by atmospheric moisture and oxygen.

### BRIEF DESCRIPTION OF THE DRAWINGS

FIG. 1 is a cross sectional view of a conventional organic electro-luminescence display panel.

FIG. 2A is a flow chart of process for fabricating an organic electro-luminescence display panel according to one embodiment of the present invention.

FIG. 2B is a cross sectional view of an organic electro-luminescence display panel according to a first embodiment of the present invention.

FIG. 3 is a cross sectional view of an organic electro-luminescence display panel according to a second embodiment of the present invention.

FIG. 4 is a cross sectional view of an organic electro-luminescence display panel according to a third embodiment of the present invention.

FIG. 5 is a cross sectional view of an organic electro-luminescence display panel according to a fourth embodiment of the present invention.

FIG. 6A is a flow chart of process for fabricating an organic electro-luminescence display panel according to another embodiment of the present invention.

FIG. 6B is a cross sectional view of an organic electro-luminescence display panel according to a fifth embodiment of the present invention.

FIG. 7 is a cross sectional view of an organic electro-luminescence display panel according to a sixth embodiment of the present invention.

FIG. 8 is a cross sectional view of an organic electro-luminescence display panel according to a seventh embodiment of the present invention.

FIG. 9A is a cross sectional view of an organic electro-luminescence display panel having an adverse structure according to one embodiment of the present invention.

FIG. 9B is a cross sectional view of an organic electro-luminescence display panel having a vertical structure according to one embodiment of the present invention.

FIG. 9C is a cross sectional view of an organic electro-luminescence display panel having a positive structure according to one embodiment of the present invention.

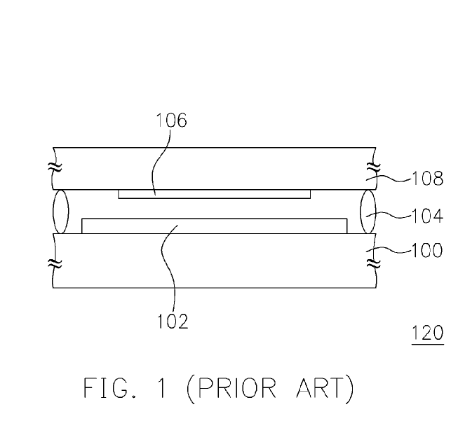

### DESCRIPTION OF EMBODIMENTS

Various specific embodiments of the present invention are disclosed below, illustrating examples of various possible implementations of the concepts of the present invention. The following description is made for the purpose of illustrating the general principles of the invention and should not be taken in a limiting sense. The scope of the invention is best determined by reference to the appended claims.

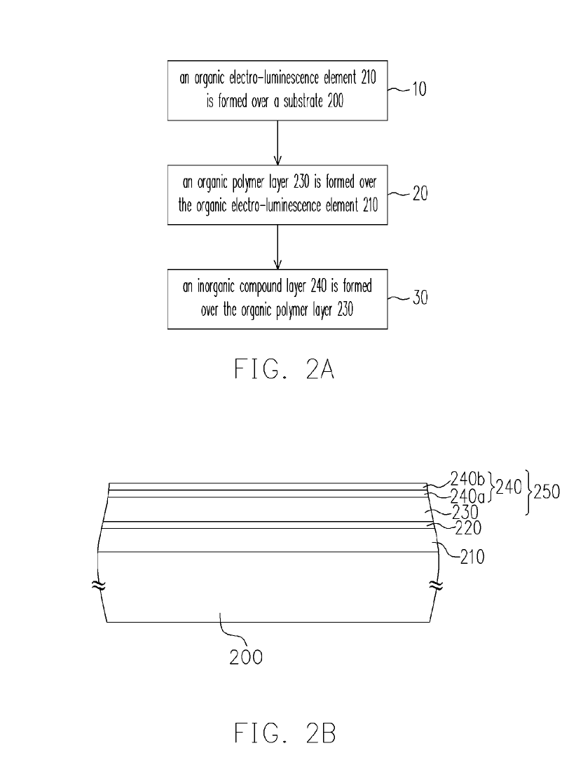

FIG. 2A is a flow chart of process for fabricating an organic electro-luminescence display panel according to one embodiment of the present invention. FIG. 2B is a cross sectional view of an organic electro-luminescence display panel according to a first embodiment of the present invention. Referring to FIGS. 2A and 2B, in step 10, an organic electro-luminescence element 210 is formed over a substrate 200, wherein the type of the organic electro-luminescence element 210 can be active matrix or passive matrix.

Next, in step 20, an organic polymer layer 230 is formed over the organic electro-luminescence element 210, wherein the material of the organic polymer layer 230 comprises parylene, acrylic, methacrylic, polyester(PET), polyethyleneterephthalate, polyethylene(PE) or polypropylene. For example, the organic polymer layer 230 can be formed by using a spin coating process or the chemical vapor deposition process. If the material of the organic polymer layer 230 is parylene, a pyrolisis vapor deposition process is used. It should be noted that, when the organic polymer layer is directly deposited on a surface of the organic electro-luminescence element 210, the organic polymer layer may react with the organic polymer monomer. Therefore, a transparent protection layer 220 is formed on the surface of the organic electro-luminescence element 210 before forming the stack structure. Wherein, the material of the transparent protection layer 220 comprises calcium fluoride or magnesium fluoride, and it can be formed by using a deposition process.

Next, in step 30, an inorganic compound layer 240 comprising at least two inorganic films is formed over the organic polymer layer 230, wherein the material of the inorganic films comprises silicon oxide or silicon oxynitride. For example, the inorganic compound layer 240 may be formed by using a plasma diffusion deposition process, i.e. ionized molecules of gas formed by plasma are deposited on the surface of the substrate due to the diffusion effect. In one embodiment, the inorganic compound layer 240 comprised of silicon oxide layer 240a is formed over the organic polymer layer 230, and then a first silicon oxynitride layer 240b is formed over the silicon oxide layer 240a. Especially, the interface between the silicon oxide layer 240a and the first silicon oxynitride layer 240b comprises a material mixed with silicon oxide and silicon oxynitride.

However, it is not necessary the sequence of forming the silicon oxide layer 240a and the first silicon oxynitride layer 240b in a manner described above FIG. 3 is a cross sectional view of a organic electro-luminescence display panel according to a second embodiment of the present invention. As shown in FIG. 3, the first silicon oxynitride layer 240b is formed over the organic polymer layer 230, and then the silicon oxide layer 240a is formed over the first silicon oxynitride layer 240b.

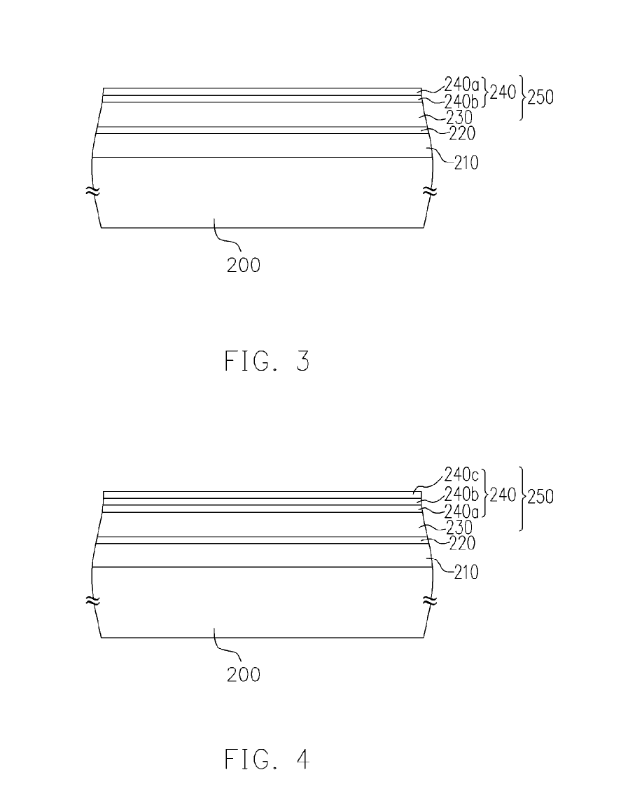

The above-mentioned inorganic compound layer 240 is composed of two inorganic layers. However, it should be noted that the inorganic compound layer 240 can be composed of three inorganic layers. FIG. 4 is a cross sectional view of an organic electro-luminescence display panel according to a third embodiment of the present invention. Referring to FIG. 4, a silicon oxide layer 240a, a first silicon oxynirtide layer 240b and a silicon oxide layer 240c are sequentially formed over the organic polymer layer 230.

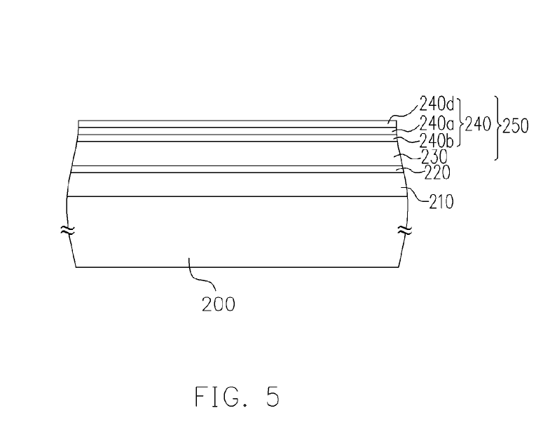

FIG. 5 is a cross sectional view of an organic electro-luminescence display panel according to a fourth embodiment of the present invention. Referring to FIG. 5, in this embodiment, the first silicon oxynitride layer 240b, the silicon oxide layer 240a and the second silicon oxynitride layer 240d are sequentially formed over the organic polymer layer 230.

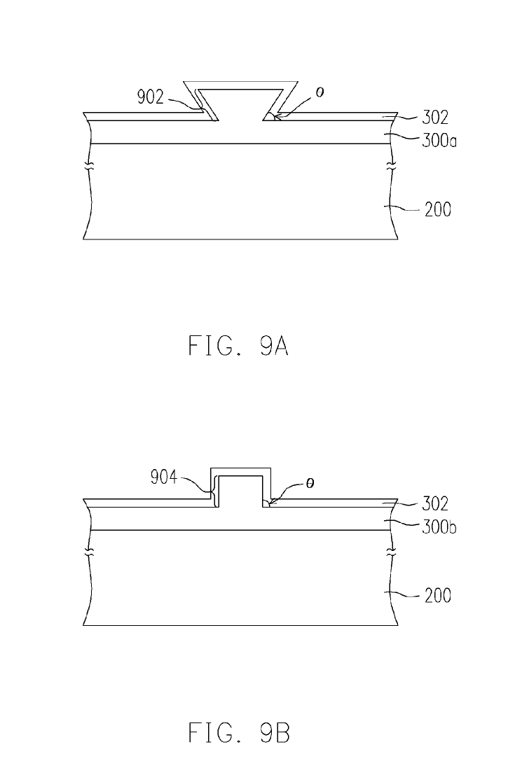

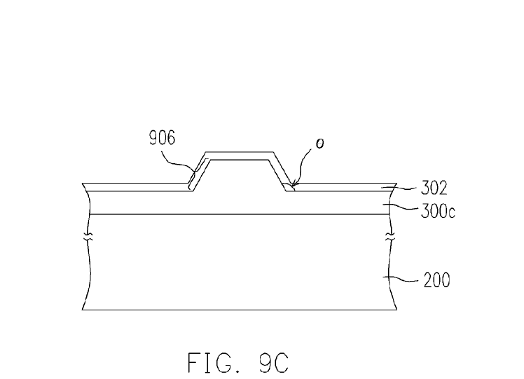

It should be noted that the composition of the aforementioned inorganic compound layer can exceed more than three inorganic layers. It should be noted that one skilled in the art may use any number of the inorganic compound layer according to the design requirement, and detailed description thereof is omitted. In addition, the interface between the above-mentioned silicon oxide layer and the foregoing silicon oxynitride layer comprises a material mixed with silicon oxide and silicon oxynitride, wherein the thickness of the interface is about one hundred and fifty (150) angstroms. Referring to FIGS. 9A, 9B and 9C, it should be noted that the material layers 300a, 300b and 300c covered with an inorganic layer 302 (or an inorganic compound layer 302) over the substrate 200 has an adverse structure 902 (Θ<90°), a vertical structure 904 (Θ=90°) and a positive structure 906 (Θ>90°) respectively. Wherein, the material layers 300a, 300b and 300c are compound layers comprising such as the organic electro-luminescence element 210 or the organic electro-luminescence element 210 and the transparent protection layer 220, or the compound layers comprising such as the organic electro-luminescence element 210, the transparent protection layer 220 and the organic polymer layer 230. The inorganic layer 302 (or the inorganic compound layer 302) provided by the present invention has excellent coverage when the structure covered with the inorganic layer 302 (or the inorganic compound layer 302) is the adverse structure 902 shown in FIG. 9A, the vertical structure 904 shown in FIG. 9B or the positive structure 906 shown in FIG. 9C. And a method of forming the inorganic layer 302 (or the inorganic compound layer 302) is such as a deposition method in plasma diffusion.

The aforementioned stack structure 250 formed over the organic electro-luminescence element 210 comprises an organic polymer layer 230 and an inorganic compound layer 240. As described above, the sequence of forming the organic polymer layer 230 and the inorganic compound layer 240 over the substrate can be flexible.

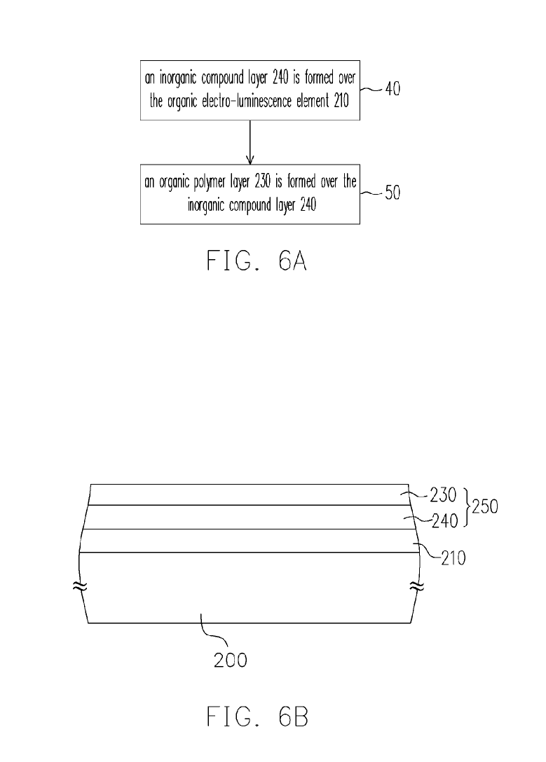

FIG. 6A is a flow chart of process for fabricating an organic electro-luminescence display panel according to another embodiment of the present invention. FIG. 6B is a cross sectional view of an organic electro-luminescence display panel according to a fifth embodiment of the present invention. Referring to FIGS. 6A and 6B, the stack structure 250 is formed by forming an inorganic compound layer 240 over the organic electro-luminescence element 210 first (step 40), and then forming an organic polymer layer 230 over the inorganic compound layer 240 (step 50).

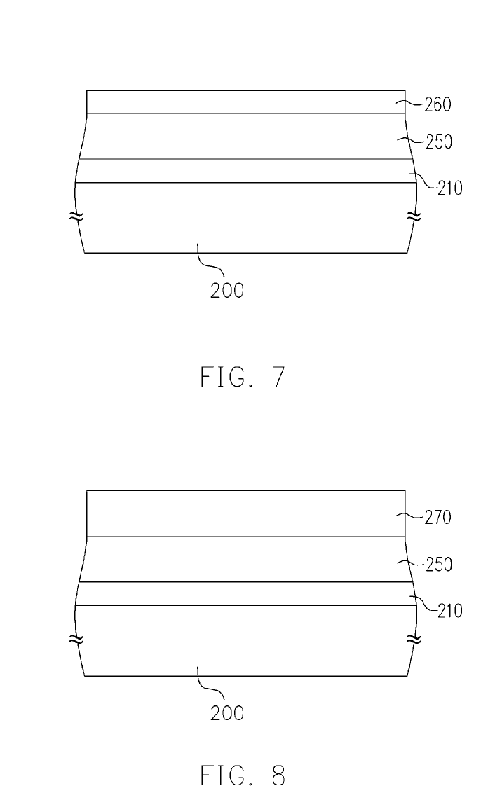

FIG. 7 is a cross sectional view of an organic electro-luminescence display panel according to a sixth embodiment of the present invention. As shown in FIG. 7, a layer structure 260 may be formed over the stack structure 250, wherein the layer structure 260 can be an organic polymer layer or an inorganic compound layer depending on the material of the upper most layer of the stack structure 250. Wherein, when the upper most layer of the stack structure 250 is an organic polymer layer, the layer structure 260 is an inorganic compound layer and vice versa.

FIG. 8 is a cross sectional view of an organic electro-luminescence display panel according to a seventh embodiment of the present invention. As shown in FIG. 8, another stack structure 270 is further formed over the stack structure 250, which may be comprised of various types of aforementioned stack structure 250. It should be noted that the interface between the two stack structures 250, 270 are stacked according to above stacking rule, i.e. depending on the material of the upper most layer of the stack structure 250.

Likewise, any number of stack structures comprising any number of organic polymer layers and inorganic compound layers may be formed over the organic electro-luminescence element 210 to the requirement. It should be noted that when an organic polymer layer need to be formed over the organic electro-luminescence element 210, it is desirable to form a transparent protection layer 220 in between the organic polymer layer and the organic electro-luminescence element 210.

Hereinafter, the structure of the organic electro-luminescence display panel is described with reference to FIG. 2. The organic electro-luminescence display panel comprises a substrate 200, an organic electro-luminescence element 210 and a stack structure 250. Wherein the organic electro-luminescence element 210 formed over the substrate 200 can be an active matrix or a passive matrix. The organic electro-luminescence element 210 is covered by the stack structure 250. In one embodiment, the organic electro-luminescence display panel comprises a transparent protection layer 220 disposed between the organic electro-luminescence element 210 and the stack structure 250.

The stack structure 250 is composed of an organic polymer layer 230 and an inorganic compound layer 240, wherein the organic electro-luminescence element 210 is covered by the organic polymer layer 230 and the inorganic compound layer 240 is disposed over the organic polymer layer 230. Wherein the inorganic compound layer 240 comprises at least two inorganic films that are stacked with each other. In one embodiment, the inorganic compound layer 240 comprises a silicon oxide layer 240a and a first silicon oxynitride layer 240b, wherein the silicon oxide layer 240a is disposed over the organic polymer layer 230 and the first silicon oxynitride layer 240b is disposed over the silicon oxide layer 240a. The organic polymer layer 230 and the inorganic compound layer 240 are adapted for reducing penetration of atmospheric moisture and oxygen into the organic electro-luminescence element 210 and thereby reduce damage to the organic electro-luminescence display panel.

In addition, the sequence of forming the silicon oxide layer 240a and the first silicon oxynitride layer 240b are not limited. As described in second embodiment with reference to FIG. 3, the first silicon oxynitride layer 240b is disposed over the organic polymer layer 230 and the silicon oxide layer 240a is disposed over the first silicon oxynitride layer 240b.

In the third embodiment of the present invention, the inorganic compound layer 240 comprises three inorganic films. As shown in FIG. 4, a silicon oxide 240a, a first silicon oxynitride 240b and a silicon oxide 240c are disposed in sequence over the organic polymer layer 230 to serve as the inorganic compound layer 240.

In the fourth embodiment of the present invention, as shown in FIG. 5, a first silicon oxynitride 240b, a silicon oxide 240a and a second silicon oxynitride 240d are disposed in sequence over the organic polymer layer 230 forming the inorganic compound layer 240.

It should be noted that the number of the disposed inorganic compound layers mentioned above can exceed more than three layers. Therefore, one skilled in the art can use any number of the inorganic compound layer achieve the purpose of the present invention, and a detailed description thereof will not described herein. In addition, the interface between the silicon oxide layer 240a and the first silicon oxynitride layer 240b comprises a material mixed with silicon oxide and silicon oxynitride, wherein the thickness of the interface is such as about one hundred and fifty angstroms (150 Å).

In the fifth embodiment of the present invention, as shown in FIG. 6, the inorganic compound layer 240 can be pre-disposed over the organic electro-luminescence element 210, and then the organic polymer layer 230 is disposed over the inorganic compound layer 240.

In the sixth embodiment of the present invention, as shown in FIG. 7, another layer structure 260 is disposed over the stack structure 250, wherein the layer structure 260 can be the organic polymer layer or the inorganic compound layer depending on the material of the upper most layer of the stack structure 250. When the most upper layer of the stack structure 250 is an organic polymer layer, the layer structure 260 is an inorganic compound layer and vice versa.

In the seventh embodiment of the present invention, as shown in FIG. 8, another stack structure 270 is further disposed over the stack structure 250. It should be noted that, the interface between the two stack structures 250, 270 is formed by mutually stacked organic polymer layer and inorganic compound layer.

Besides the aforementioned various structures of the organic electro-luminescence display panel, the composition of the organic electro-luminescence display panel may be other than those described above and the arrangement of layers described above may also adopted to achieve the purpose of the present invention.

Accordingly, the present invention has the following advantages: 1. The stack structure comprising the organic polymer layer and the inorganic compound layer can effectively reduce penetration of atmospheric moisture and oxygen into the organic electro-luminescence element and thereby effectively reduce damage to the organic electro-luminescence element. 2. The stack structure, which is formed by deposition process, can be applied to flexible substrates, and the thickness and weight of the stack structure can be effectively controlled within a range to develop thinner and lighter organic electro-lumescence elements.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A process of fabricating an organic electro-luminescence display panel, comprising:
forming an organic electro-luminescence element over a substrate; and
forming a stack structure over the substrate covering the organic electro-luminescence element, wherein the stack structure comprises an organic polymer layer and an inorganic compound layer, and wherein the inorganic compound layer is composed of at least two inorganic films, and the interface between the inorganic films comprising a material mixed with materials of the two inorganic films.

2. The process of fabricating an organic electro-luminescence display panel of claim 1, wherein the step of forming the inorganic compound layer comprises:
sequentially forming a silicon oxide layer and a silicon oxynitride layer or vice versa, wherein the interface between the silicon oxide layer and the silicon oxynitride layer comprising a material mixed with silicon oxide and silicon oxynitride.

3. The process of fabricating an organic electro-luminescence display panel of claim 1, wherein the step of forming the inorganic compound layer comprises:
sequentially forming a first silicon oxide layer, a silicon oxynitride layer and a second silicon oxide layer or sequentially forming a first silicon oxynitride layer, a silicon oxide layer and a second silicon oxynitride layer.

4. The process of fabricating an organic electro-luminescence display panel of claim 1, wherein the process of forming the inorganic compound layer comprises a plasma diffusion deposition process.

5. The process of fabricating an organic electro-luminescence display panel of claim 1, further comprising a step of forming a transparent protection layer over the substrate to cover the organic electro-luminescence element before the step of forming the organic polymer layer.

6. The process of fabricating an organic electro-luminescence display panel of claim 5, wherein a material of the transparent protection layer comprises calcium fluoride or magnesium fluoride.

7. The process of fabricating an organic electro-luminescence display panel of claim 1, further comprising a step of forming another organic polymer layer or another inorganic compound layer over the stack structure.

8. The process of fabricating an organic electro-luminescence display panel of claim 1, further comprising a step of forming another stack structure over the stack structure, wherein the another stack structure comprises an organic polymer layer and an inorganic compound layer.

9. The process of fabricating an organic electro-luminescence display panel of claim 1, wherein a material of the organic polymer layer is selected from the group consisting of parylene, acrylic, methacrylic, polyester(PET), polyethyleneterephthalate, polyethylene(PE), polypropylene and the combination thereof.

10. The process of fabricating an organic electro-luminescence display panel of claim 1, wherein a type of the organic electro-luminescence element comprises passive matrix or active matrix.

11. An organic electro-luminescence display panel, comprising:
an organic electro-luminescence element, disposed over a substrate; and
a stack structure, covering the organic electro-luminescence element, comprising an organic polymer layer and an inorganic compound layer, wherein the inorganic compound layer comprises at least two mutually stacked inorganic films, and an interface between the inorganic films comprises a material mixed with materials of the two inorganic films.

12. The organic electro-luminescence display panel of claim 11, wherein the inorganic compound layer comprises a silicon oxide layer and a silicon oxynitride layer, and an interface between the silicon oxide layer and the silicon oxynitride layer comprising silicon oxide and silicon oxynitride.

13. The organic electro-luminescence display panel of claim 11, wherein the inorganic compound layer comprises a first silicon oxide layer, a silicon oxynitride layer and a second silicon oxide layer in sequence or a first silicon oxynitride layer, a silicon oxide layer and a second silicon oxynitride layer in sequence.

14. The organic electro-luminescence display panel of claim 11, further comprising a transparent protection layer disposed between the organic electro-luminescence element and the stack structure.

15. The organic electro-luminescence display panel of claim 14, wherein the material of the transparent protection layer comprising calcium fluoride or magnesium fluoride.

16. The organic electro-luminescence display panel of claim 11, further comprising another organic polymer layer or another inorganic compound layer covering the stack structure.

17. The organic electro-luminescence display panel of claim 11, further comprising another stack structure comprising the organic polymer layer and the inorganic compound layer covering the stack structure.

18. The organic electro-luminescence display panel of claim 11, wherein the material of the organic polymer layer is selected from the group consisting parylene, acrylic, methacrylic, polyester(PET), polyethyleneterephthalate, polyethylene(PE), polypropylene and the combination thereof.

19. The organic electro-luminescence display panel of claim 11, wherein a type of the organic electro-luminescence element is passive matrix or active matrix.
